(19) United States
(12) Patent Application Publication
(10) Pub. No.: US 2024/0048822 A1
(43) Pub. Date: Feb. 8, 2024

(54) IMAGE CAPTURE APPARATUS AND CONTROL METHOD FOR SAME

(71) Applicant: CANON KABUSHIKI KAISHA, Tokyo (JP)

(72) Inventor: Shota YAMAGUCHI, Tokyo (JP)

(21) Appl. No.: 18/359,556

(22) Filed: Jul. 26, 2023

(30) Foreign Application Priority Data
Aug. 4, 2022 (JP) 2022-124991

(51) Int. Cl. H04N 23/11; G06T 7/00; G06T 5/00; G06T 5/50; G06T 7/20

(52) U.S. Cl. CPC H04N 23/11; G06T 7/0002; G06T 5/007; G06T 5/50; G06T 7/20; G06T 2207/20221

(57) ABSTRACT

Disclosed in an image capture apparatus that can acquire a visible-light image and an invisible-light image. The apparatus determines a method of using information in order to apply predetermined processing to the visible-light image, wherein the information is based on the invisible-light image. The apparatus generates information based on the invisible-light image in accordance with the result of the determination and record, in a recording medium, a data file with which the visible-light image, information indicating the result of the determination, and the information based on the invisible-light image are associated.

### BACKGROUND OF THE INVENTION

### Field of the Invention

The present invention relates to an image capture apparatus and a control method for the image capture apparatus.

### Description of the Related Art

There is proposed a technique for compositing, with a visible-light image in which a scene having low visibility due to fog is captured, an infrared-light image in which the same scene is captured, and thereby improving the visibility of the visible-light image (Japanese Patent Laid-Open No. 2017-157902).

However, it is not the case that the visibility of a visible-light image can always be improved by compositing an infrared-light image therewith, and a suitable compositing method needs to be chosen. There are also cases in which it cannot be expected that visibility will improve by compositing an infrared-light image. Furthermore, in some case, it may be more suitable to use information of an infrared-light image in a method other than compositing to improve the visibility of a visible-light image.

Conventionally, an image capture apparatus capable of recording an invisible-light image such as an infrared-light image in addition to a visible-light image did not provide information for assisting another apparatus in executing processing for improving the visibility of the visible-light image using information of the invisible-light image. Thus, it was not easy for the other apparatus to improve the visibility of the visible-light image using the information of the invisible-light image in a suitable manner. Also, an image capture apparatus capable of recording visible-light images having differing exposure amounts did not provide information allowing another apparatus to execute processing using these images in a suitable manner.

### SUMMARY OF THE INVENTION

The present invention solves one or more of such problems with the prior art. In one aspect thereof, the present invention provides an image capture apparatus that can record information for assisting an external apparatus in applying predetermined processing to a visible-light image using information based on an invisible-light image in a suitable manner, and a control method for the image capture apparatus.

According to an aspect of the present invention, there is provided an image capture apparatus that can acquire a visible-light image and an invisible-light image, the image capture apparatus comprising: one or more processors that execute a program stored in a memory and thereby function as: a determination unit configured to determine a method of using information in order to apply predetermined processing to the visible-light image, wherein the information is based on the invisible-light image; a generation unit configured to generate information based on the invisible-light image in accordance with the result of the determination; and a recording unit configured to record, in a recording medium, a data file with which the visible-light image, information indicating the result of the determination, and the information based on the invisible-light image generated by the generation unit are associated.

According to another aspect of the present invention, there is provided an image processing apparatus comprising one or more processors that execute a program stored in a memory and thereby function as: an acquisition unit configured to acquire the data file recorded by the image capture apparatus according to the present invention; an extraction unit configured to extract, from the data file, the information indicating the result of the determination, the visible-light image, and the information based on the invisible-light image; and a processing unit configured to apply the predetermined processing to the visible-light image by using the information based on the invisible-light image according to the method indicated by the information indicating the result of the determination.

According to a further aspect of the present invention, there is provided an image capture apparatus control method to be executed by an image capture apparatus that can acquire a visible-light image and an invisible-light image, the image capture apparatus control method comprising: determining a method of using information in order to apply predetermined processing to the visible-light image, wherein the information is based on the invisible-light image; generating information based on the invisible-light image in accordance with the result of the determination in the determining; and recording, in a recording medium, a data file with which the visible-light image, information indicating the result of the determination, and the information based on the invisible-light image generated by the generating are associated.

According to another aspect of the present invention, there is provided an image capture apparatus that can record a first visible-light image shot with correct exposure and a second visible-light image shot with an exposure amount lower than the correct exposure, the image capture apparatus comprising one or more processors that execute a program stored in a memory and thereby function as: a determination unit configured to determine a method of expanding a dynamic range of the first visible-light image or the second visible-light image; and a recording unit configured to record, in a recording medium, a data file with which information indicating the result of the determination, and at least the second visible-light image out of the first visible-light image and the second visible-light image are associated.

According to a further aspect of the present invention, there is provided an image capture apparatus control method to be executed by an image capture apparatus that can record a first visible-light image shot with correct exposure and a second visible-light image shot with an exposure amount lower than the correct exposure, the image capture apparatus control method comprising: determining a method for expanding a dynamic range of the first visible-light image or the second visible-light image; and recording, in a recording medium, a data file with which information indicating the result of the determination, and at least the second visible-light image out of the first visible-light image and the second visible-light image are associated.

According to another aspect of the present invention, there is provided a non-transitory computer-readable medium having stored therein a program for causing a computer included in an image capture that can acquire a visible-light image and an invisible-light image, to function as: a determination unit configured to determine a method of using information in order to apply predetermined processing to the visible-light image, wherein the information is based on the invisible-light image; a generation unit configured to generate information based on the invisible-light image in accordance with the result of the determination; and a recording unit configured to record, in a recording medium, a data file with which the visible-light image, information indicating the result of the determination, and the information based on the invisible-light image generated by the generation unit are associated.

According to a further aspect of the present invention, there is provided a non-transitory computer-readable medium having stored therein a program for causing a computer to function as an image processing apparatus comprising: an acquisition unit configured to acquire the data file recorded by the image capture apparatus according to the present invention; an extraction unit configured to extract, from the data file, the information indicating the result of the determination, the visible-light image, and the information based on the invisible-light image; and a processing unit configured to apply the predetermined processing to the visible-light image by using the information based on the invisible-light image according to the method indicated by the information indicating the result of the determination.

According to another aspect of the present invention, there is provided a non-transitory computer-readable medium having stored therein a program for causing a computer, included in an image capture apparatus that can record a first visible-light image shot with correct exposure and a second visible-light image shot with an exposure amount lower than the correct exposure, to function as: a determination unit configured to determine a method of expanding a dynamic range of the first visible-light image or the second visible-light image; and a recording unit configured to record, in a recording medium, a data file with which information indicating the result of the determination, and at least the second visible-light image out of the first visible-light image and the second visible-light image are associated.

Further features of the present invention will become apparent from the following description of exemplary embodiments (with reference to the attached drawings).

### BRIEF DESCRIPTION OF THE DRAWINGS

FIG. 1 is a block diagram illustrating an example of a functional configuration of an image capture apparatus according to the embodiments.

FIG. 2 is a block diagram schematically illustrating processing executed by an image processing unit of the image capture apparatus in a first embodiment.

FIG. 3 is a diagram illustrating examples of visible-light and infrared-light images.

FIG. 4 is a flowchart relating to operations of an additional-information generation unit in the first embodiment.

FIG. 5 is a flowchart relating to operations of an additional-image generation unit in the first embodiment.

FIG. 6 is a flowchart relating to a gain-map creation operation in the first embodiment.

FIGS. 7A and 7B are diagrams illustrating an example of a gain-amount determination method in the first embodiment.

FIG. 8 is a block diagram illustrating an example of a functional configuration of an image processing apparatus in the first embodiment.

FIG. 9 is a block diagram schematically illustrating processing executed by an image processing unit in the first embodiment.

FIG. 10 is a flowchart relating to visibility improvement processing in the first embodiment.

FIG. 11 is a block diagram schematically illustrating processing executed by the image processing unit in a second embodiment.

FIG. 12 is a flowchart relating to operations of a quality adjustment unit in the second embodiment.

FIG. 13 is a block diagram schematically illustrating processing executed by the image processing unit of the image capture apparatus in a third embodiment.

FIG. 14 is a flowchart relating to operations of the additional-information generation unit in the third embodiment.

FIG. 15 is a block diagram schematically illustrating processing executed by the image processing unit of the image processing apparatus in the third embodiment.

FIG. 16 is a flowchart relating to dynamic-range expansion processing in the third embodiment.

FIG. 17 is a diagram illustrating an example of a compositing ratio in the third embodiment.

FIG. 18 is a diagram illustrating an example of a gain amount in the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the following, with reference to the attached drawings, the present invention will be described in detail based on exemplary embodiments thereof. Note that the following embodiments do not limit the invention in the claims. Furthermore, while a plurality of features are described in the embodiments, not all of the features are necessarily essential to the invention, and multiple features may be combined as appropriate. Furthermore, the same reference numerals are given to the same or similar configurations in the attached drawings, and redundant description thereof will be omitted.

Note that, in the following, embodiments in which the present invention is implemented in a digital camera will be described. However, the present invention can be implemented in any electronic device having an image capture function. Such electronic devices include video cameras, computer devices (personal computers, tablet computers, media players, PDAs, etc.), portable telephones, smartphones, game machines, robots, drones, and drive recorders. These are examples, and the present invention can also be implemented in other electronic devices.

Note that the features represented as blocks in the drawings can be realized using an integrated circuit (IC) such as an ASIC or FPGA, using discrete circuits, or using a combination of a memory and a processor executing programs stored in the memory. Furthermore, one block may be realized using a plurality of integrated circuit packages, or multiple blocks may be realized using one integrated circuit package. Also, one same block may be implemented using different configurations depending on the operating environment, the required performance, etc.

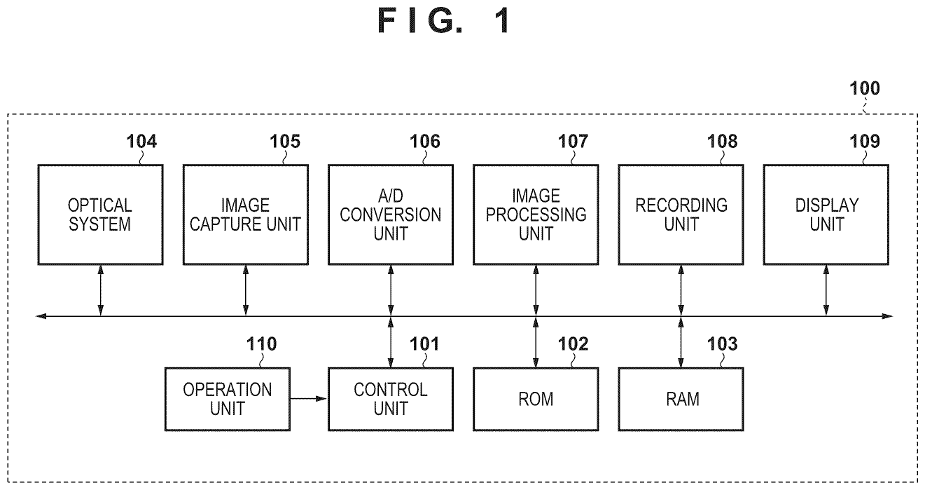

FIG. 1 is a block diagram illustrating one example of a functional configuration of an image capture apparatus 100, which is one example of an image processing apparatus according to the present invention. A control unit 101 is a processor, such as a CPU for example, that can execute programs. The control unit 101 controls operations of the functional blocks of the image capture apparatus 100 and realizes the functions of the image capture apparatus 100 by loading programs stored in a ROM 102 onto a RAM 103 and executing the programs, for example. Note that, if an optical system 104 is an interchangeable lens unit, the control unit 101 controls operations of the optical system 104 through communication with a controller included in the optical system 104.

The ROM 102 is a rewritable non-volatile memory. The ROM 102 stores programs executed by the control unit 101, various setting values and GUI data of the image capture apparatus 100, etc. The RAM 103 is the main memory of the control unit 101. The RAM 103 is used: to load programs to be executed by the control unit 101; to hold parameters necessary to execute the programs; and as a work memory of an image processing unit 107. Furthermore, a partial region of the RAM 103 is used as a video memory for storing image data to be displayed on a display unit 109.

The optical system 104 includes an image capture optical system constituted from a lens group including movable lenses (zoom lens, focus lens, and the like), and a driving circuit for the movable lenses. The optical system 104 may include an aperture and a driving circuit for the aperture.

An image capture unit 105 may be a known CCD or CMOS color image sensor including color filters in a primary-color Bayer array. The image sensor includes a pixel array in which a plurality of pixels are two-dimensionally arranged, and a peripheral circuit for reading signals from the pixels. Each pixel includes a photoelectric conversion element such as a photodiode, and accumulates electric charge corresponding to an incident light amount during an exposure period. A pixel signal group (analog image signal) representing a subject image formed on an imaging surface by the image capture optical system can be obtained by reading, from each pixel, a signal having a voltage corresponding to the amount of electric charge accumulated during the exposure period.

Note that, in the present embodiment, the image capture unit 105 includes an image sensor that can capture a visible-light image and an invisible-light image. For example, in such an image sensor, some of the plurality of pixels included in the pixel array may be configured as pixels for capturing the invisible-light image. The pixels for capturing the invisible-light image may be pixels including an optical filter having a characteristic of transmitting an invisible-light wavelength band and blocking the visible-light wavelength region.

For example, one of the two green (G) filters included in a repetition unit (2×2 pixels) of color filters in the primary-color Bayer array is replaced with an optical bandpass filter that transmits wavelengths of invisible light (e.g., infrared light). Thus, one of the green (G) pixels can be changed into a pixel for capturing the invisible-light image. Upon generating the visible-light image, the value of the G pixel that should be present at the position of the pixel for capturing the invisible-light image can be generated by performing interpolation using the values of nearby G pixels, for example. Furthermore, the resolution (i.e., the number of pixels) of the invisible-light image can be equalized with that of the visible-light image by performing enlargement processing on the image obtained based on the signals of the pixels for capturing the invisible-light image.

Note that the methods for acquiring the visible-light image and the invisible-light image are not limited, and the visible-light image and the invisible-light image may be acquired according to other methods. For example, an image sensor for shooting the visible-light image and an image sensor for shooting the invisible-light image may be provided separately. Furthermore, while the invisible-light image is an infrared-light image in the present embodiment, the invisible-light image may be an image of a different invisible wavelength band.

An A/D conversion unit 106 converts the analog image signal read from the image capture unit 105 into a digital image signal. The A/D conversion unit 106 writes the digital image signal to the RAM 103.

The image processing unit 107 generates a signal or image data that is suitable for the purpose of use, or acquires and/or generates various types of information by applying predetermined image processing to the digital image signal stored in the RAM 103. For example, the image processing unit 107 may be a dedicated hardware circuit, such as an ASIC, that is designed to realize a specific function, or may be configured such that a specific function is realized by a programmable processor, such as a DSP, executing software.

The image processing applied by the image processing unit 107 includes pre-processing, color interpolation processing, correction processing, detection processing, data processing, evaluation-value calculation processing, special-effects processing, and the like.

The pre-processing includes signal amplification, reference-level adjustment, defective-pixel correction, and the like.

The color interpolation processing is processing for interpolating values of color components that cannot be obtained during shooting, and is also referred to as demosaicing processing.

The correction processing includes processing such as white-balance adjustment, tone correction, the correction of image degradation caused by the optical aberration of the optical system 104 (image recovery), the correction of the effect of vignetting of the optical system 104, and color correction. Furthermore, the later-described processing for compositing the infrared-light image in order to improve the visibility of the visible-light image is also included in the correction processing.

The detection processing includes the detection of characteristic regions (e.g., face regions and human-body regions) and the movement thereof, person recognition processing, and the like.

The data processing includes processing such as compositing, scaling, encoding/decoding, and the generation of header information (generation of a data file).

The evaluation-value calculation processing includes processing such as the generation of signals and an evaluation value to be used for automatic focus detection (AF), and the generation of an evaluation value to be used for automatic exposure control (AE). Note that AE and AF are executed by the control unit 101 based on evaluation values. Furthermore, the generation of information of the infrared-light image and information relating to the method of use of the infrared-light image, which will be described later, is also included in this processing.

The special-effects processing includes processing such as the addition of blur, the changing of color tone, and relighting.

Note that these are examples of processing that can be applied by the image processing unit 107, and do not limit the processing to be applied by the image processing unit 107.

For example, a recording unit 108 records data to a recording medium such as a memory card, and reads data recorded on the recording medium. The recording medium need not be detachable. Furthermore, the recording medium may be an external storage device that can perform communication. In the present embodiment, the recording unit 108 can also record information of the infrared-light image and information relating to the method of use of the infrared-light image in addition to the visible-light image.

The display unit 109 is a liquid-crystal display for example, and displays captured images, images read by the recording unit 108, information about the image capture apparatus 100, GUIs such as a menu screen, etc. By continuously executing the shooting of a moving image and displaying, on the display unit 109, of the moving image that is being shot, the display unit 109 can be caused to function as an electronic view finder (EVF). Note that the display unit 109 may be a touch display.

An operation unit 110 collectively refers to input devices (buttons, switches, dials, etc.) provided so that a user could input instructions to the image capture apparatus 100. Each of the input devices constituting the operation unit 110 has a name corresponding to the function allocated thereto. For example, the operation unit 110 includes a release switch, a moving-image recording switch, a shooting-mode selection dial for selecting a shooting mode, a menu button, a directional key, an enter key, etc. The release switch is a switch for recording a still image, and the control unit 101 recognizes a half-pressed state of the release switch as a shooting preparation instruction and a fully-pressed state of the release switch as a shooting start instruction. Furthermore, the control unit 101 recognizes a press of the moving-image recording switch during a shooting standby state as a moving-image recording start instruction and a press of the moving-image recording switch during the recording of a moving image as a recording stop instruction. Note that the function allocated to one input device may be variable. Furthermore, the input devices may be software buttons or keys realized using a touch display.

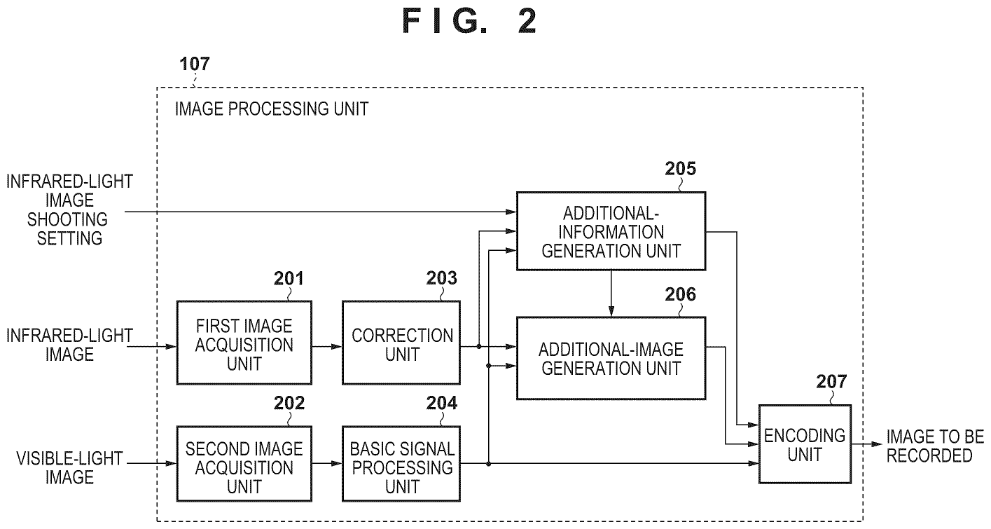

FIG. 2 is a block diagram in which a sequence of processing executed by the image processing unit 107 in the present embodiment is schematically represented using functional blocks. The features that are illustrated as functional blocks may be implemented by separate pieces of hardware or as software modules.

Note that shooting has been performed prior to the execution of the processing described below, and data of a visible-light image and data of an infrared-light image obtained by the shooting are already stored in the RAM 103. However, data of an infrared-light image does not need to be generated at all times. For example, data of an infrared-light image may be generated depending on the shooting mode or other settings.

A first image acquisition unit 201 acquires the data of the infrared-light image stored in the RAM 103. Furthermore, a second image acquisition unit 202 acquires the data of the visible-light image stored in the RAM 103. Note that, if the image sensor is provided with pixels for the infrared-light image and the infrared-light image and the visible-light image have been acquired by performing shooting once, the first image acquisition unit 201 adjusts the resolution of the infrared-light image to the resolution of the visible-light image. Furthermore, the second image acquisition unit 202 calculates the values of the visible-light image at the positions of the pixels for the infrared-light image from the values of nearby pixels.

A correction unit 203 applies predetermined correction processing to the infrared-light image. For example, the correction processing includes noise removal processing. In addition, the correction processing includes level adjustment processing for adjusting the brightness of the infrared-light image to the brightness of the visible-light image. Furthermore, the correction processing also includes processing for correcting image distortion caused by the aberration of the optical system 104. These are examples, and other types of correction processing may be applied.

A basic signal processing unit 204 applies predetermined signal processing to the visible-light image. The signal processing applied here includes noise removal processing, gamma correction processing, color interpolation processing, conversion from the RGB format to the YCbCr format, optimization processing, and the like. These are examples, and other types of signal processing may be applied.

An additional-information generation unit 205 generates additional information, which is an indicator or a flag indicating a predetermined one of a plurality of methods of use of the infrared-light image. For example, the additional-information generation unit 205 can generate the additional information based on one or more out of information that can be obtained from the infrared-light image and the visible-light image, and shooting settings of the infrared-light image. The operations of the additional-information generation unit 205 will be described in detail later.

An additional-image generation unit 206 generates, in accordance with the additional information (or the method indicated by the additional information), an additional image that is to be recorded in association with the visible-light image. Note that, depending on the additional information, there may be no additional image, or the infrared-light image may be directly used as the additional image. The additional image is data having a format that can be used to improve the visibility of the visible-light image associated therewith. The operations of the additional-image generation unit 206 will be described in detail later.

The combination of the additional information and the additional image is information for assisting an external apparatus in applying predetermined processing (here, processing for improving visibility) to the visible-light image by using information based on the invisible-light image in a suitable manner.

An encoding unit 207 generates a single data file that contains the visible-light image, the additional information, and the additional image. For example, the encoding unit 207 can generate file data conforming to a known container format. The encoding unit 207 stores the generated file data in the RAM 103. The recording unit 108 reads the file data from the RAM 103 and records the file data to the recording medium as a file.

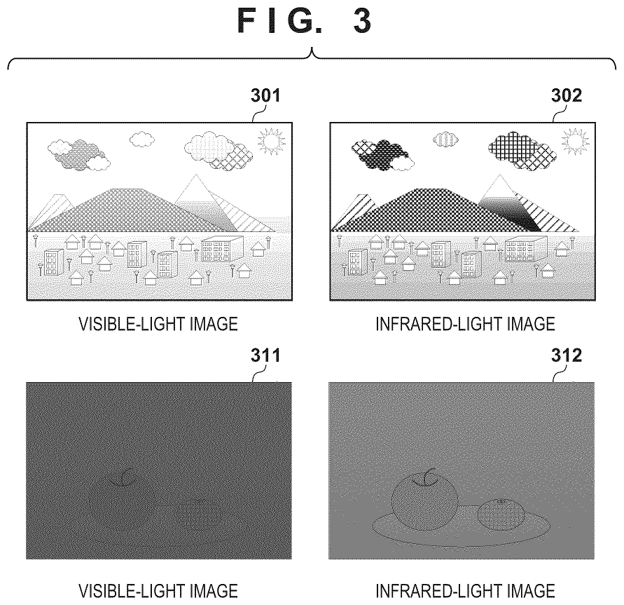

Here, specific examples in which the visibility of the visible-light image can be improved using the infrared-light image will be described with reference to FIG. 3. Visible-light images 301 and 311 schematically illustrate examples of visible-light images whose visibility can be improved using infrared-light images. The visible-light image 301 is an image with correct exposure but low contrast due to fog or haze. Furthermore, the visible-light image 311 is an image that is dark due to underexposure. An infrared-light image 302 is an infrared-light image in which the same scene as that in the visible-light image 301 is captured. Furthermore, an infrared-light image 312 is an infrared-light image in which the same scene as that in the visible-light image 311 is captured.

The visibility of the visible-light image 301 with sufficient brightness can be improved by compositing alternating-current (AC) components of the infrared-light image 302 therewith. On the other hand, the visibility of the visible-light image 311 with insufficient brightness can be improved by directly compositing the infrared-light image 312 therewith. Note that the infrared-light image and the visible-light image are composited in units of individual pixels in a state in which the two images are aligned. The compositing in units of individual pixels may be processing in which a value of the infrared-light image is added to a luminance component of the visible-light image.

States of the visible-light image in which it can be expected that visibility will improve by using the infrared-light image are not limited to the examples illustrated in FIG. 3. Similarly, methods of use of the infrared-light image are not limited to the methods of use that have been explained here.

In such a manner, the method of use of the infrared-light image that is suitable for improving the visibility of the visible-light image varies depending on the characteristics of the visible-light image. Furthermore, depending on the shooting settings of the visible-light image and the infrared-light image, there are cases in which it cannot be expected that visibility will improve by compositing the infrared-light image.

Thus, the additional-information generation unit 205 determines whether or not the infrared-light image is to be used and how the infrared-light image is to be used, if the infrared-light image is to be used, and generates the additional information based on the determination results.

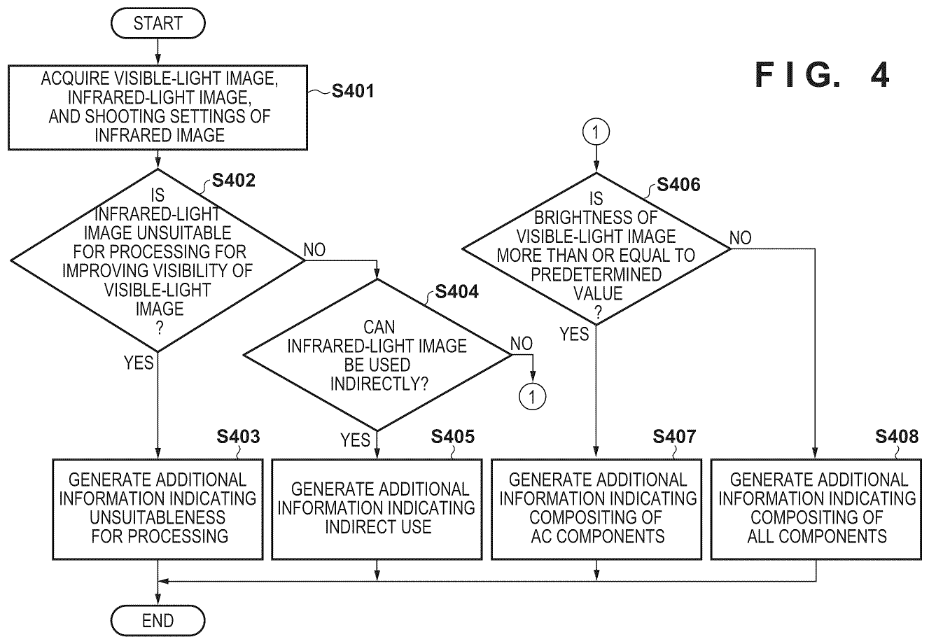

The operations of the additional-information generation unit 205 will be described with reference to the flowchart illustrated in FIG. 4.

In step S401, the additional-information generation unit 205 acquires the infrared-light image, the visible-light image, and the shooting settings of the infrared-light image from the correction unit 203, the basic signal processing unit 204, and the control unit 101, respectively.

In step S402, the additional-information generation unit 205 determines whether the infrared-light image is unsuitable for improving the visibility of the visible-light image. For example, the additional-information generation unit 205 can determine that the infrared-light image is unsuitable for improving the visibility of the visible-light image when it can be considered that the infrared-light image includes significant subject blur or image blur.

For example, it can be considered that at least one of image blur and subject blur is large if the shutter speed when the infrared-light image was shot was slower than a first speed threshold. Furthermore, it can be considered that image blur is large if the movement of the image capture apparatus 100 during shooting was greater than a first movement threshold. For example, the movement of the image capture apparatus 100 can be detected using a gyrosensor provided for image-blur correction.

The additional-information generation unit 205 executes step S403 if it is determined that the infrared-light image is unsuitable for improving the visibility of the visible-light image, and otherwise executes step S404.

In step S403, the additional-information generation unit 205 generates additional information indicating unsuitableness for processing, and terminates the additional-information generation processing.

In step S404, the additional-information generation unit 205 determines whether or not the infrared-light image can be used indirectly, although being unsuitable for direct compositing (whether or not the infrared-light image is of an indirectly-usable level). Here, the additional-information generation unit 205 can determine that the infrared-light image is of the indirectly-usable level when it can be considered that at least one of subject blur and image blur in the infrared-light image is present in a degree such that the condition in step S402 is not fulfilled. Accordingly, the additional-information generation unit 205 can perform a determination in a manner similar to step S402 using a second speed threshold that is faster than the first speed threshold and a second movement threshold that is smaller than the first movement threshold.

Furthermore, the additional-information generation unit 205 can also determine that the infrared-light image is of the indirectly-usable level when the shooting timings of the infrared-light image and the visible-light image were different. For example, a case in which the infrared-light image and the visible-light image were acquired by continuous shooting corresponds to this. This is because, when the visible-light image and the infrared-light image were shot at different shooting timings, the ranges that are captured may not match and there may be a change in positions of moving subjects between the visible-light image and the infrared-light image. The additional-information generation unit 205 may determine that the infrared-light image is unsuitable for processing when the difference between shooting timings is greater than or equal to a threshold, and determine that the infrared-light image is of the indirectly-usable level when the difference is smaller than the threshold (>0).

The additional-information generation unit 205 executes step S405 if it is determined that the infrared-light image is of the indirectly-usable level, and otherwise executes step S406.

In step S405, the additional-information generation unit 205 generates additional information indicating indirect use, and terminates the additional-information generation processing.

In step S406, the additional-information generation unit 205 determines whether or not the brightness of the visible-light image is more than or equal to a brightness threshold. For example, the brightness may be a luminance evaluation value used for automatic exposure control (AE), the average luminance value within a predetermined region in the image, or some other value relating to brightness. The additional-information generation unit 205 executes step S407 if it is determined that the brightness of the visible-light image is more than or equal to the brightness threshold, and otherwise executes step S408.

In step S407, the additional-information generation unit 205 generates additional information indicating compositing of AC components of the infrared-light image, and terminates the additional-information generation processing.

In step S408, the additional-information generation unit 205 generates additional information indicating compositing of all components (i.e., the infrared-light image itself), and terminates the additional-information generation processing.

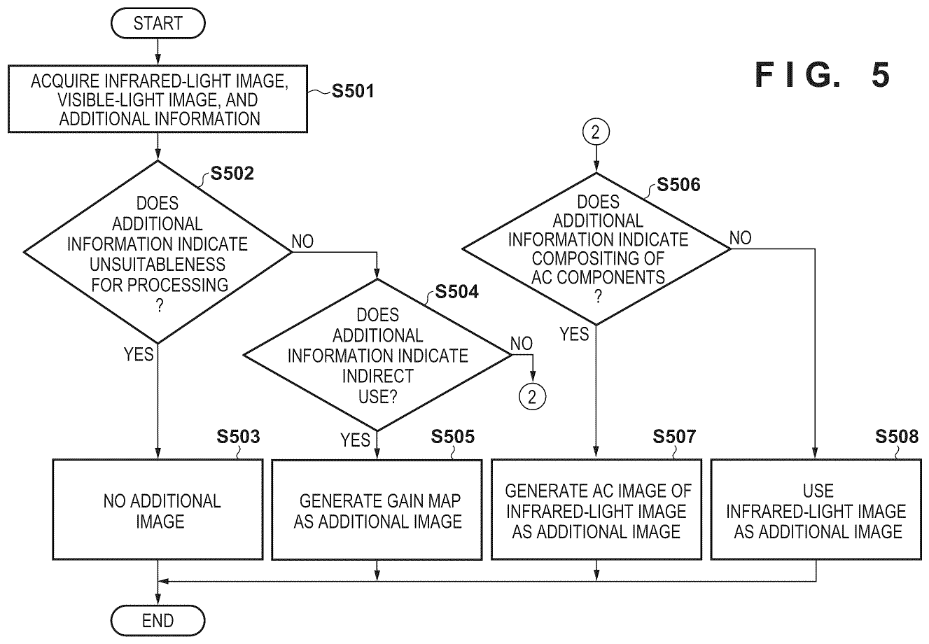

Next, the operations of the additional-image generation unit 206 will be described with reference to the flowchart illustrated in FIG. 5.

In step S501, the additional-image generation unit 206 acquires the infrared-light image, the visible-light image, and the additional information from the correction unit 203, the basic signal processing unit 204, and the additional-information generation unit 205, respectively.

In step S502, the additional-image generation unit 206 determines whether or not the additional information indicates unsuitableness for processing, and executes step S503 if it is determined that the additional information indicates unsuitableness for processing and otherwise executes step S504.

In step S503, the additional-image generation unit 206 terminates the additional-image generation processing without generating an additional image.

In step S504, the additional-image generation unit 206 determines whether or not the additional information indicates indirect use, and executes step S505 if it is determined that the additional information indicates indirect use and otherwise executes step S506.

In step S505, the additional-image generation unit 206 generates a gain map as an additional image. The gain map is data indicating the gain that is to be multiplied with the luminance (Y) component of each pixel in the visible-light image in order to improve the visibility of the visible-light image.

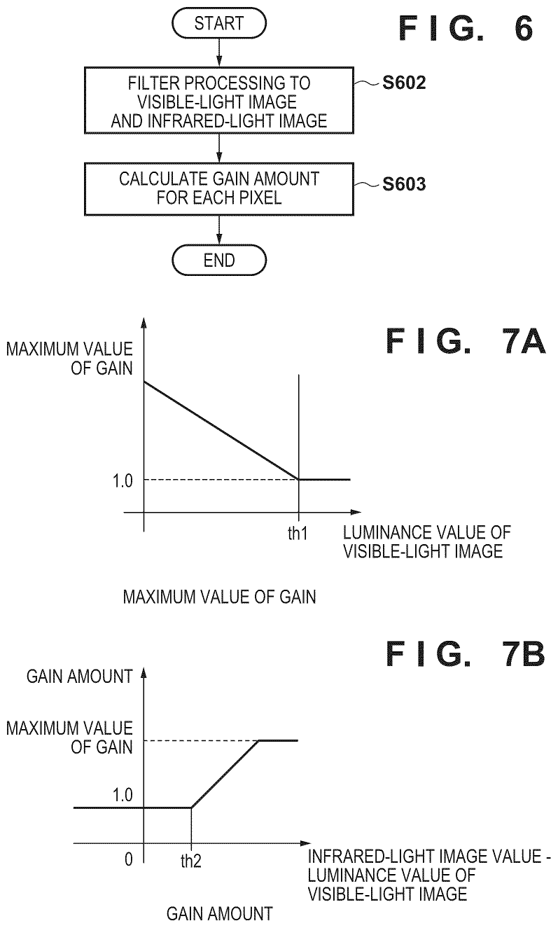

The method for generating the gain map in step S505 will be described with reference to the flowchart in FIG. 6.

In step S602, the additional-image generation unit 206 applies filter processing to each of the infrared-light image and the visible-light image acquired in step S501. The filter applied here is a filter for reducing high-frequency components, such as a smoothing filter or a low-pass filter. The frequency characteristics of the filter can be determined, as appropriate, through experimentation or the like. By reducing high-frequency components, a decrease in contrast that would otherwise be caused by the application of gain amounts can be suppressed.

In step S603, the additional-image generation unit 206 generates a gain map by determining, for each pixel, a gain amount to be applied to the visible-light image. For example, the additional-image generation unit 206 determines a gain amount exceeding 1 for, among the pixels in the visible-light image having luminance values equal to a lower than a threshold, each pixel for which the difference between the luminance value of the pixel and the value of the pixel located at a corresponding position in the infrared-light image is greater than equal to a threshold. The term “corresponding pixel” refers to a pixel that is located at the same position (coordinates) in an image as a target pixel.

FIGS. 7A and 7B are diagrams illustrating an example of a gain-amount determination method. First, in accordance with the luminance value of the target pixel in the visible-light image, the additional-image generation unit 206 determines a maximum gain amount for the target pixel. FIG. 7A illustrates an example of the relationship between luminance values and maximum gain amounts.

As illustrated in FIG. 7A, the maximum gain amount is determined as 1 for a target pixel having a luminance value that is higher than or equal to a threshold th1. Because the minimum gain amount is 1, the brightness of a pixel having a luminance value that is higher than or equal to the threshold th1 does not change. On the other hand, for a target pixel having a luminance value that is lower than the threshold th1, the maximum gain amount is determined so as to be greater than 1 and such that the lower the luminance value, the greater the maximum gain amount. In such a manner, a maximum gain amount is determined for each pixel.

Next, for the target pixel in the visible-light image, the additional-image generation unit 206 determines a gain amount that is greater than or equal to 1 and that is equal to or smaller than the maximum gain amount, in accordance with the difference (difference in signal level) between the luminance value of the target pixel and the value of a pixel located at a corresponding position in the infrared-light image. Here, the difference in signal level is a value obtained by subtracting the luminance value in the visible-light image from the value in the infrared-light image. FIG. 7B illustrates an example of the relationship between the difference in signal level and the gain amount that is determined.

As illustrated in FIG. 7B, the gain amount for the target pixel is determined as 1 if the difference in signal level is smaller than a threshold th2. Accordingly, the brightness does not change for pixels having a luminance value higher than the value in the infrared-light image and for pixels for which the luminance value is lower than the value in the infrared-light image but the difference between the values is smaller than the threshold th2. On the other hand, for a target pixel for which the difference in signal level is greater than or equal to the threshold th2, the gain amount is determined such that the greater the difference in signal level, the greater the gain amount, up to the maximum gain amount determined earlier. Once the maximum gain amount is reached, the maximum gain amount is set as the final gain amount.

The additional-image generation unit 206 can hold tables or calculation formulas corresponding to FIGS. 7A and 7B in advance. Furthermore, the additional-image generation unit 206 can determine the gain amount to be applied to the target pixel using the luminance value and signal level difference of the target pixel, and the tables or calculation formulas.

Having determined a gain amount for each pixel in the visible-light image, the additional-image generation unit 206 outputs a gain map constituted from the determined gain amounts to the encoding unit 207 as an additional image.

Returning to FIG. 5, in step S506, the additional-image generation unit 206 determines whether or not the additional information indicates compositing of AC components, and executes step S507 if it is determined that the additional information indicates compositing of AC components and otherwise executes step S508.

In step S507, the additional-image generation unit 206 generates an AC image of the infrared-light image as an additional image. The additional-image generation unit 206 can generate an AC image of the infrared-light image by applying high-pass filter processing to the infrared-light image. The characteristics of the high-pass filter can be determined in advance through experimentation or the like. The additional-image generation unit 206 outputs the generated AC image to the encoding unit 207 as an additional image.

In step S508, the additional-image generation unit 206 outputs the infrared-light image itself to the encoding unit 207 as an additional image.

Next, an image processing apparatus that is an external apparatus that uses the data file recorded by the image capture apparatus 100 will be described. The image processing apparatus may be any electronic device. Such electronic devices include computer devices (personal computers, tablet computers, media players, PDAs, etc.), portable telephones, smartphones, game machines, robots, drones, and drive recorders, but there is no limitation to such devices.

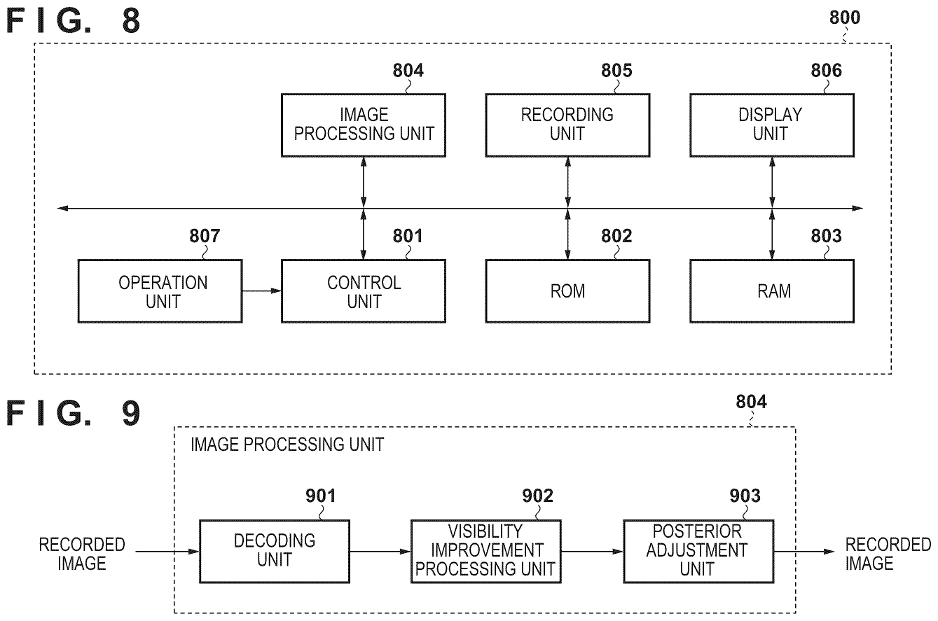

FIG. 8 is a block diagram illustrating an example of the functional configuration of an image processing apparatus 800.

A control unit 801 is a CPU for example, and controls the operations of the blocks included in the image processing apparatus 800 by reading operation programs of the blocks included in the image processing apparatus 800 from a later-described ROM 802, and deploying and executing the operation programs in a later-described RAM 803. The ROM 802 is an electrically erasable and recordable non-volatile memory, and stores parameters, etc., that are necessary for the operation of the blocks included in the image processing apparatus 800, in addition to the operation programs of the blocks. The RAM 803 is a rewritable volatile memory, and is used as a temporary storage region for data output during the operation of the blocks included in the image processing apparatus 800.

For example, the control unit 801 is a processor (CPU, MPU, microprocessor, or the like) that can execute programs. The control unit 801 controls operations of the units of the image processing apparatus 800 and realizes the functions described in the following by loading programs stored in the ROM 802 onto the RAM 803 and executing the programs.

The ROM 802 is a rewritable non-volatile memory, and stores programs executed by the control unit 801, various setting values of the image processing apparatus 800, etc.

The RAM 803 is the main memory used by the control unit 801 to execute programs. Furthermore, the RAM 803 is also used as a work memory of an image processing unit 804, and as a video memory for a display unit 806.

The image processing unit 804 may be implemented as image processing hardware, such as a GPU, or may be realized by the processor executing a program. In accordance with control by the control unit 801, the image processing unit 804 executes visible-light-image visibility improvement processing, in which the visible-light image, the additional image, and the additional information recorded by the image capture apparatus 100 are used. The image processing unit 804 can also apply various types of image processing other than this.

A recording unit 805 is a recording device in which a detachable memory card is used, for example. Note that the recording unit 805 further includes another storage device, such as a hard disk drive (HDD) or a solid-state drive (SSD). Basic software (OS), application programs, user data, etc., are stored in the other storage device.

Here, a memory card in which the data file has been recorded by the image capture apparatus 100 is attached to the recording unit 805. Note that the data file recorded by the image capture apparatus 100 may be acquired from an external apparatus (including the image capture apparatus 100) via communication.

The display unit 806 includes a display device such as a liquid-crystal display (LCD), and displays graphical user interfaces (GUIs) provided by the OS and the application programs. The visible-light image and user data are displayed on GUIs (e.g., application windows) of the respective application programs that process the visible-light image and the user data.

An operation unit 807 includes one or more input devices, such as a keyboard, a mouse, and a touch panel. The operation unit 807 is used by a user of the image processing apparatus 800 to input instructions to the image processing apparatus 800. Operations performed on the operation unit 807 are monitored by the control unit 801. Upon detecting an operation performed on the operation unit 807, the control unit 801 executes an operation corresponding to the operation.

FIG. 9 is a block diagram in which a sequence of processing relating to the visible-light-image visibility improvement executed by the image processing unit 804 is schematically represented using functional blocks. The features that are illustrated as functional blocks may be implemented by separate pieces of hardware or as software modules.

For example, while executing an image processing application, the control unit 801 is instructed by the user to read image data recorded in the memory card attached to the recording unit 805. The control unit 801 acquires the image data designated by the user from the recording unit 805, and stores the image data to the RAM 803. Furthermore, the control unit 801 displays the read image in a window of the image processing application. Here, the read image data is data of the visible-light image, in association with which the additional information and the additional image are recorded.

Upon receiving, for the displayed image, an instruction to execute the visibility improvement processing from the user as a result of the user operating a menu of the image processing application for example, the control unit 801 instructs the image processing unit 804 to execute the visibility improvement processing. Thus, the image processing unit 804 executes the visibility improvement processing described in the following.

A decoding unit 901 extracts, from the container-format data file stored in the RAM 103, data of the visible-light image, data of the additional information, and data of the additional image.

Based on the additional information and the additional image, a visibility improvement processing unit 902 applies the processing for improving visibility to the visible-light image. The visibility improvement processing unit 902 stores the processed visible-light image data in the RAM 803. The operations of the visibility improvement processing unit 902 will be described in detail later.

A posterior adjustment unit 903 applies predetermined posterior adjustment to the data of the visible-light image to which the visibility improvement processing has been applied. For example, the posterior adjustment involves the adjustment of color and brightness, the adjustment of the tone curve, etc., as designated by the user. Upon completion of the posterior adjustment, the control unit 801 records the data of the visible-light image to which the posterior adjustment has been applied to the recording unit 805 as image data to which the visibility improvement processing has been applied.

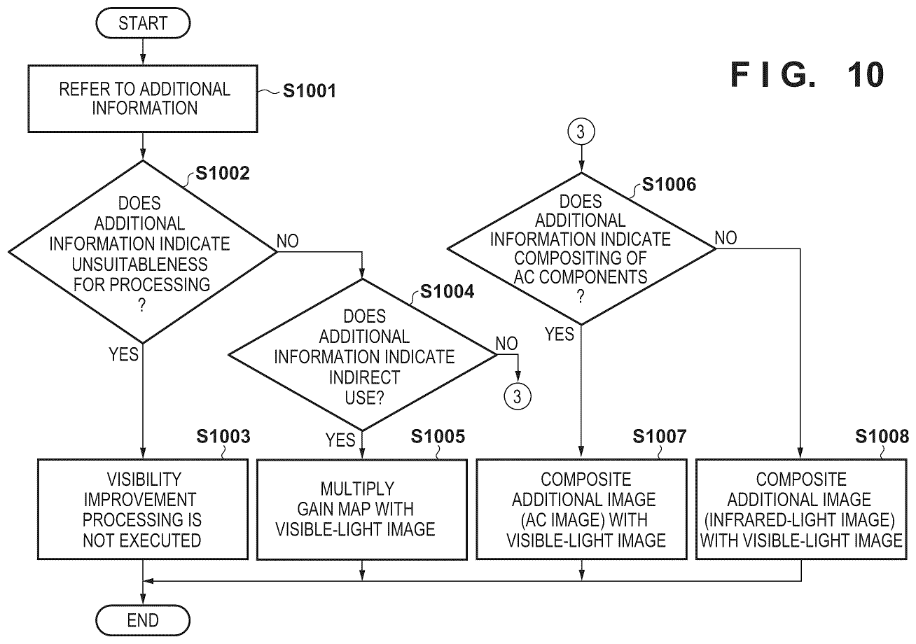

The operations of the visibility improvement processing unit 902 will be described in detail with reference to the flowchart illustrated in FIG. 10.

In step S1001, the visibility improvement processing unit 902 refers to the data of the additional information extracted by the decoding unit 901.

In step S1002, the visibility improvement processing unit 902 determines whether or not the additional information indicates unsuitableness for processing, and executes step S1003 if it is determined that the additional information indicates unsuitableness for processing and otherwise executes step S1004.

In step S1003, the visibility improvement processing unit 902 terminates the visibility improvement processing without executing any processing. In doing so, the visibility improvement processing unit 902 may display, on the display unit 806, a message dialogue indicating that the visibility improvement processing cannot be applied to the displayed image.

In step S1004, the visibility improvement processing unit 902 determines whether or not the additional information indicates indirect use, and executes step S1005 if it is determined that the additional information indicates indirect use and otherwise executes step S1006.

In step S1005, the visibility improvement processing unit 902 recognizes, based on the additional information, that the additional image is a gain map. Furthermore, the visibility improvement processing unit 902 applies a gain amount based on the gain map to the luminance value of each pixel in the visible-light image (i.e., multiplies the luminance value by the gain amount). Note that, if the visible-light image that is read is in the RGB format, the visibility improvement processing unit 902 multiples the luminance (Y) components by the gain amounts after converting the visible-light image into the YCbCr format.

The visibility improvement processing unit 902 updates the image in the application window to the visible-light image to which the gain amounts have been applied, and terminates the visibility improvement processing.

In step S1006, the visibility improvement processing unit 902 determines whether or not the additional information indicates compositing of an AC image, and executes step S1007 if it is determined that the additional information indicates compositing of an AC image and otherwise executes step S1008.

In step S1007, the visibility improvement processing unit 902 recognizes, based on the additional information, that the additional image is constituted from alternating-current components (i.e., an AC image) of the infrared-light image. Furthermore, the visibility improvement processing unit 902 composites (adds) the AC image with the luminance components of the visible-light image. Specifically, the visibility improvement processing unit 902 adds, to the luminance value of each pixel in the visible-light image, the pixel value at the corresponding position in the AC image.

The visibility improvement processing unit 902 updates the image in the application window to the visible-light image with which the AC image has been composited, and terminates the visibility improvement processing.

In step S1008, the visibility improvement processing unit 902 recognizes, based on the additional information, that the additional image is the infrared-light image itself. Furthermore, the visibility improvement processing unit 902 composites (adds) the infrared-light image with the luminance components of the visible-light image. Specifically, the visibility improvement processing unit 902 adds, to the luminance value of each pixel in the visible-light image, the pixel value at the corresponding position in the infrared-light image.

The visibility improvement processing unit 902 updates the image in the application window to the visible-light image with which the infrared-light image has been composited, and terminates the visibility improvement processing.

As described above, the image capture apparatus according to the present embodiment records, in association with a visible-light image, information (additional image) based on an infrared-light image and information indicating a method of use of the additional image, both of which can be used to improve the visibility of the visible-light image. Thus, an external apparatus can easily improve the visibility of the visible-light image using the additional image. Furthermore, because the image capture apparatus generates the additional image in a form that is suitable for improving the visibility of the visible-light image, an external apparatus can improve the visibility of the visible-light image according to the most-suitable method by simply using the additional image according to the indicated method of use. Furthermore, the storage capacity of a recording medium can be used more effectively compared to a case in which the infrared-light image is always recorded in association with the visible-light image.

Note that a configuration may be adopted such that, in the visibility improvement processing by the image processing apparatus, the user can adjust the strength (%) of the gain amounts to be actually applied, based on the gain amounts indicated by the gain map (100%). Similarly, a configuration may be adopted such that, also in the compositing of an AC image or an infrared-light image, the user can adjust the ratio (%) at which the image is to be actually added, based on the ratio (100%) in a case in which the image is directly added.

Furthermore, while the additional information indicates one of four types of processing methods in the present embodiment, the addition information may indicate three or less or five or more types of processing methods. Note that, if additional information indicating a new processing method is to be introduced, an additional image is also configured in conformity with the method.

While an example has been described in the present embodiment in which the processing applied to the visible-light image using the information based on the invisible-light image is processing for improving visibility, the processing may be that of a different type. Furthermore, the invisible-light image is not limited to an infrared-light image.

### Second Embodiment

Next, a second embodiment of the present invention will be described, focusing on portions that are different from the first embodiment.

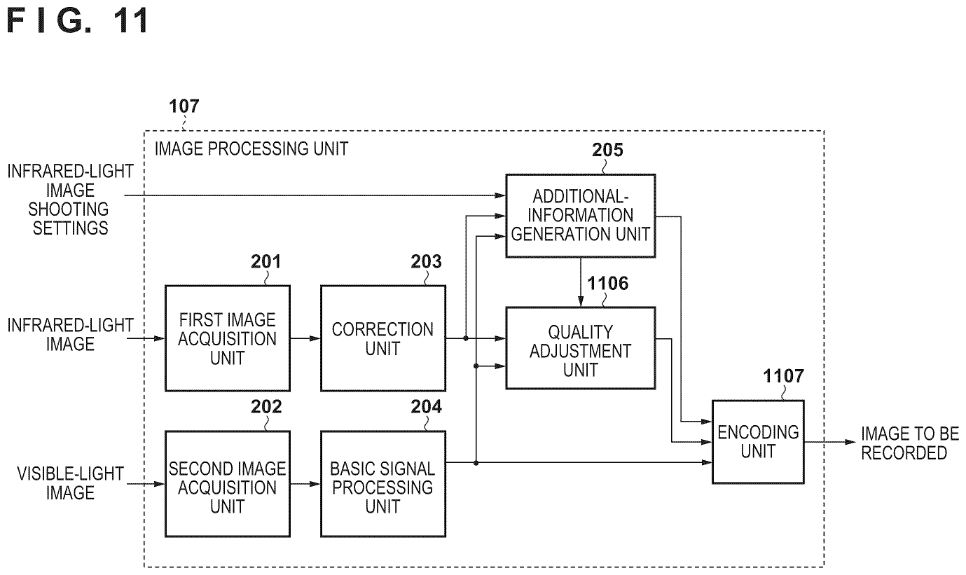

FIG. 11 is a block diagram in which a sequence of processing executed by the image processing unit 107 in the second embodiment is schematically represented using functional blocks. The same reference numerals as those in FIG. 2 are given to functional blocks that execute processing that is the same as that in the first embodiment, and description thereof will be omitted.

The image processing unit 107 in the present embodiment includes a quality adjustment unit 1106 in place of the additional-image generation unit 206. Furthermore, the data processed by an encoding unit 1107 is different from that in the first embodiment. Thus, the operations of the quality adjustment unit 1106 and the encoding unit 1107 will be described in the following.

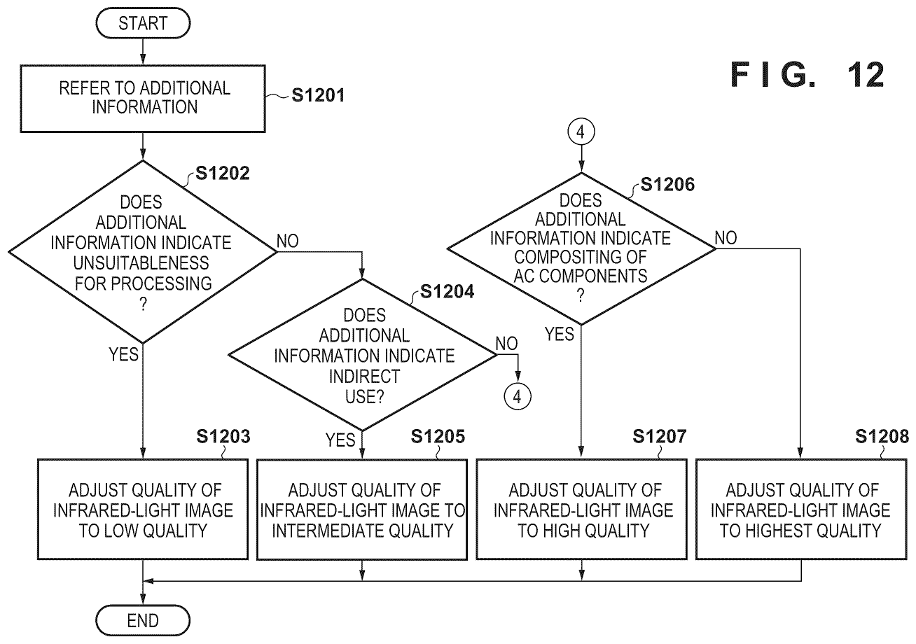

First, the operations of the quality adjustment unit 1106 will be described with reference to the flowchart illustrated in FIG. 12.

In step S1201, the quality adjustment unit 1106 refers to the additional information acquired from the additional-information generation unit 205.

In step S1202, the quality adjustment unit 1106 determines whether or not the additional information indicates unsuitableness for processing, and executes step S1203 if it is determined that the additional information indicates unsuitableness for processing and otherwise executes step S1204.

In step S1203, the quality adjustment unit 1106 adjusts the quality of the infrared-light image acquired from the correction unit 203 to low quality. Here, parameters corresponding to four levels of quality are set in advance, and, among the different levels, there is a difference in one or more arbitrarily defined known parameters that affect image quality, such as resolution, the number of bits per pixel, and the compression ratio during lossy coding. Furthermore, in step S1203, the quality adjustment unit 1106 adjusts the quality of the infrared-light image in accordance with the parameters corresponding to the lowest quality among the four levels of quality. The quality adjustment unit 1106 outputs the infrared-light image whose quality has been adjusted to the encoding unit 1107 as an additional image.

In step S1204, the quality adjustment unit 1106 determines whether or not the additional information indicates indirect use, and executes step S1205 if it is determined that the additional information indicates indirect use and otherwise executes step S1206.

In step S1205, the quality adjustment unit 1106 adjusts the quality of the infrared-light image acquired from the correction unit 203 to intermediate quality. The intermediate quality is the second lowest among the four levels of quality. The quality adjustment unit 1106 outputs the infrared-light image whose quality has been adjusted to the encoding unit 1107 as an additional image.

In step S1206, the quality adjustment unit 1106 determines whether or not the additional information indicates compositing of an AC image, and executes step S1207 if it is determined that the additional information indicates compositing of an AC image and otherwise executes step S1208.

In step S1207, the quality adjustment unit 1106 adjusts the quality of the infrared-light image acquired from the correction unit 203 to high quality. The high quality is the second highest among the four levels of quality. The quality adjustment unit 1106 outputs the infrared-light image whose quality has been adjusted to the encoding unit 1107 as an additional image.

In step S1208, the quality adjustment unit 1106 adjusts the quality of the infrared-light image acquired from the correction unit 203 to highest quality. Note that, if lossy coding is not performed, no adjustment needs to be performed on the infrared-light image in step S1208. The quality adjustment unit 1106 outputs the infrared-light image whose quality has been adjusted to the encoding unit 1107 as an additional image.

Other than the difference in the content of the additional image, the operations of the encoding unit 1107 are the same as those in the first embodiment.

The visibility improvement processing unit 902 of the image processing apparatus 800 using the data file recorded by the image capture apparatus 100 in the present embodiment recognizes, based on the additional information, the quality of the infrared-light image recorded as the additional image. Furthermore, when the additional image is a low-quality infrared-light image, the visibility improvement processing unit 902 does not execute processing for improving the visibility of the visible-light image. Also, when the infrared-light image that is the additional image is of intermediate quality, the visibility improvement processing unit 902 generates a gain map in a similar manner as the additional-image generation unit 206 in the first embodiment, and applies the gain map to the visible-light image. In addition, when the infrared-light image that is the additional image is of high quality, the visibility improvement processing unit 902 generates an AC image in a similar manner as the additional-image generation unit 206 in the first embodiment, and composites the AC image with the visible-light image. Furthermore, when the infrared-light image that is the additional image is of highest quality, the visibility improvement processing unit 902 directly composites the infrared-light image with the visible-light image.

Effects similar to those of the first embodiment can also be realized according to the present embodiment. Furthermore, instead of generating a gain map or an AC image, an additional image is generated by adjusting quality in accordance with additional information. Thus, processing is simpler and processing load is lower than in the first embodiment. Furthermore, the data amount of the additional image can be reduced if a configuration is adopted such that data amount is reduced even in the case of highest quality.

### Third Embodiment

Next, a third embodiment of the present invention will be described. The present embodiment is different from the first and second embodiments in that a visible-light image having a different exposure amount is shot in place of an invisible-light image. Furthermore, additional information and an additional image that make it easy for an external apparatus to execute visible-light-image dynamic-range expansion processing in a suitable manner are recorded.

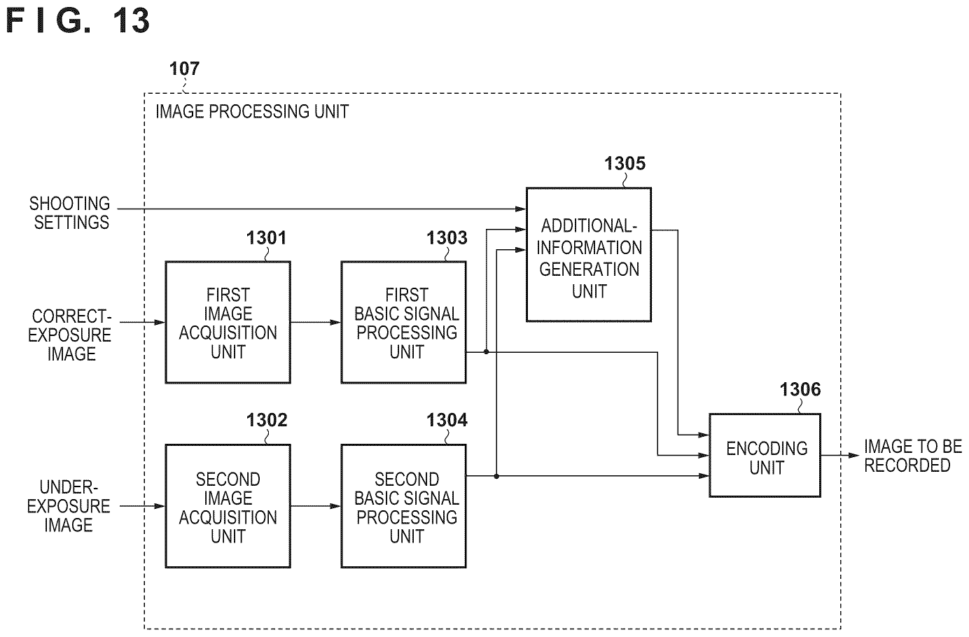

FIG. 13 is a block diagram in which a sequence of processing executed by the image processing unit 107 in the third embodiment is schematically represented using functional blocks. Note that shooting with different exposure amounts has been performed continuously prior to the execution of the processing described below, and data of two frames of visible-light images obtained by the shooting are already stored in the RAM 103.

Here, visible-light images have been shot with correct exposure and underexposure. While the same aperture value is used, the shutter speed is basically varied among the exposure conditions during shooting. The shooting sensitivity may also be varied depending on the situation. For example, the difference in exposure amount between correct exposure and underexposure is around 1 to 3 EV. In the following, the visible-light image shot with correct exposure and the visible-light image shot with an exposure amount lower than correct exposure are respectively referred to as a correct-exposure image and an underexposure image.

A first image acquisition unit 1301 acquires the data of the correct-exposure image stored in the RAM 103. Furthermore, a second image acquisition unit 1302 acquires the data of the underexposure image stored in the RAM 103.

A first basic signal processing unit 1303 and a second basic signal processing unit 1304 apply processing similar to that by the basic signal processing unit 204 in the first and second embodiments.

An additional-information generation unit 1305 generates additional information from the correct-exposure image, the underexposure image, and the shooting settings of the images. As the additional information, additional information that is an indicator or a flag indicating one of a plurality of methods of use of the correct-exposure image and the underexposure image is generated.

For example, the additional-information generation unit 1305 can generate the additional information based on one or more out of information that can be obtained from the correct-exposure image and the underexposure image, and shooting settings of the correct-exposure image. The operations of the additional-information generation unit 1305 will be described in detail later.

Other than the difference in the content of the additional information and the additional image that are recorded, an encoding unit 1306 generates file data in a similar manner as the encoding unit 207 in the first embodiment and the encoding unit 1107 in the second embodiment.

Here, dynamic-range expansion processing will be described. In typical dynamic-range expansion processing, the correct-exposure image and the underexposure image are composited at a ratio that is in accordance with the brightness of one of the two images.

However, in the shooting settings, the shutter speed of the correct-exposure image is slower than the shutter speed of the underexposure image because the same aperture value is used as discussed above. A slower shutter speed results in blurring of moving subjects and camera shake readily occurring. If subject blur or image blur is seen in the correct-exposure image (or if the possibility of subject blur or image blur occurring in the correct-exposure image is high), it is better to expand the dynamic range of the underexposure image. This is because the exposure conditions used to shoot the underexposure image include a faster shutter speed than that used for the correct-exposure image. The dynamic range of the underexposure image can be expanded by applying gradation conversion for expanding the gradation of dark portions, in particular.

However, in a case in which the dark portions of the underexposure image are noisy, the image quality following dynamic-range expansion would decrease because noise is emphasized by enlarging the gradation of the dark portions. Thus, it would be better not to perform dynamic-range expansion by gradation conversion.

The determination based on the conditions as mentioned above of whether or not the correct-exposure image and the underexposure image are suitable for dynamic-range expansion would be easier if performed during shooting (recording). Thus, recording the result of the determination performed during recording as the additional information makes it possible to assist dynamic-range expansion processing by an external apparatus.

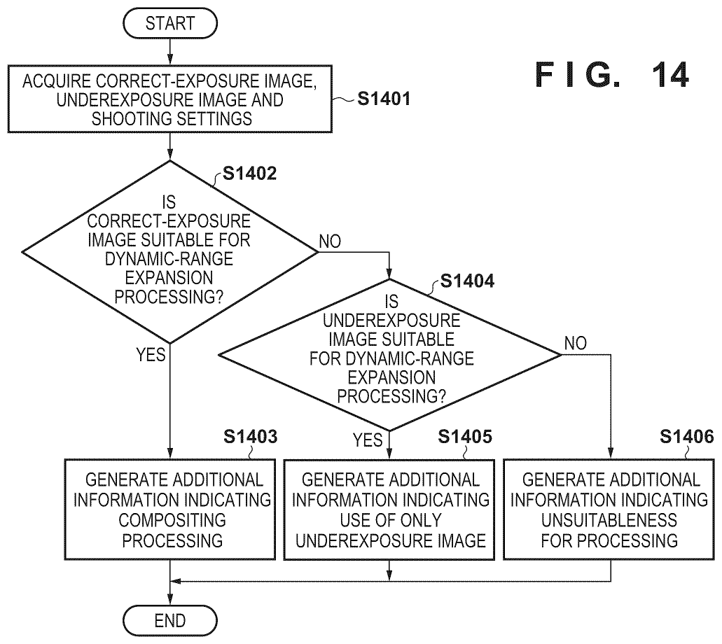

The operations of the additional-information generation unit 1305 will be described with reference to the flowchart illustrated in FIG. 14.

In step S1401, the additional-information generation unit 1305 acquires the correct-exposure image, the underexposure image, and the shooting settings of the images from the first basic signal processing unit 1303, the second basic signal processing unit 1304, and the control unit 101, respectively.

In step S1402, the additional-information generation unit 1305 determines whether or not the correct-exposure image is suitable for dynamic-range expansion processing. For example, the additional-information generation unit 1305 can determine that the correct-exposure image is unsuitable for dynamic-range expansion processing when it can be considered that the correct-exposure image includes significant subject blur or image blur.

For example, it can be considered that at least one of image blur and subject blur is large if the shutter speed when the correct-exposure image was shot was slower than a first speed threshold. Furthermore, it can be considered that image blur is large if the movement of the image capture apparatus 100 during shooting was greater than a first movement threshold. For example, the movement of the image capture apparatus 100 can be detected using a gyrosensor provided for image-blur correction.

The additional-information generation unit 1305 executes step S1404 if it is determined that the correct-exposure image is unsuitable for dynamic-range expansion processing, and otherwise executes step S1403.

In step S1403, because the correct-exposure image is suitable for dynamic-range expansion processing, the additional-information generation unit 1305 generates additional information indicating compositing processing, and terminates the additional-information generation processing.

In step S1404, the additional-information generation unit 1305 determines whether or not the underexposure image is suitable for dynamic-range expansion processing. The additional-information generation unit 1305 can determine that the underexposure image is unsuitable for dynamic-range expansion processing by gradation conversion when a predetermined condition in which the amount of noise increases is fulfilled.

For example, the condition in which the amount of noise increases may be that the shooting sensitivity of the underexposure image was higher than or equal to a sensitivity threshold, that the luminance evaluation value of the underexposure image is lower than a luminance threshold, etc. Alternatively, the additional-information generation unit 1305 may measure, as the amount of noise, an integrated value of differences between the black level and pixel values in the optical black region of the image sensor during the shooting of the underexposure image. Furthermore, the additional-information generation unit 1305 can determine that the underexposure image is unsuitable for dynamic-range expansion processing by gradation conversion when the amount of noise is more than or equal to a noise threshold.

The additional-information generation unit 1305 executes step S1406 if it is determined that the underexposure image is unsuitable for dynamic-range expansion processing, and otherwise executes step S1405.

In step S1405, because the underexposure image is suitable for dynamic-range expansion processing, the additional-information generation unit 1305 generates additional information indicating the use of only the underexposure image, and terminates the additional-information generation processing.

In step S1406, because the both the correct-exposure image and the underexposure image are unsuitable for dynamic-range expansion processing, the additional-information generation unit 1305 generates additional information indicating unsuitableness for processing, and terminates the additional-information generation processing.

If the additional information indicates unsuitableness for processing, the encoding unit 1306 generates file data which does not include an additional image and in which the additional information is recorded in association with the correct-exposure image. Furthermore, if the additional information does not indicate unsuitableness for processing, the encoding unit 1306 generates file data in which the underexposure image, which is an additional image, and the additional information are recorded in association with the correct-exposure image. The file data is recorded in the memory card attached to the recording unit 108.

Next, an image processing apparatus that is an external apparatus that uses the data file recorded by the image capture apparatus 100 will be described. Other than the operations of the image processing unit 804, the image processing apparatus according to the present embodiment may be similar to the image processing apparatus 800 described in the first embodiment. Thus, redundant description will be omitted, and the operations of the image processing unit 804 will be mainly described in the following.

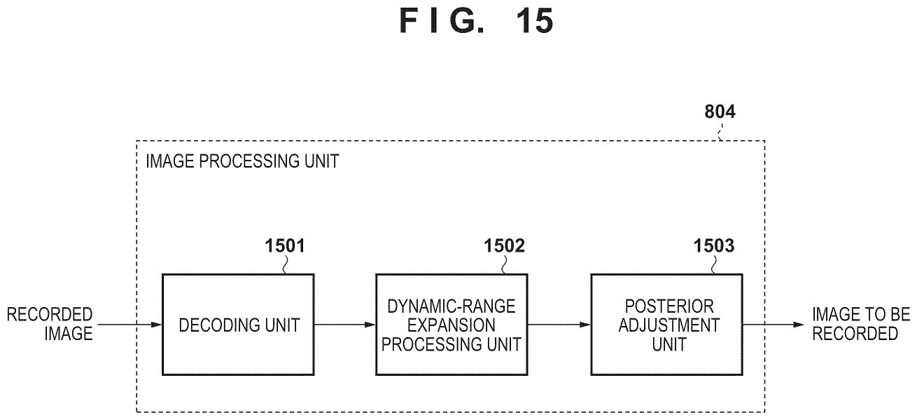

FIG. 15 is a block diagram in which a sequence of processing relating to dynamic-range expansion executed by the image processing unit 804 in the present embodiment is schematically represented using functional blocks. The features that are illustrated as functional blocks may be implemented by separate pieces of hardware or as software modules.

For example, while executing an image processing application, the control unit 801 is instructed by the user to read image data recorded in the memory card attached to the recording unit 805. The control unit 801 acquires the image data designated by the user from the recording unit 805, and stores the image data to the RAM 803. Furthermore, the control unit 801 displays the read image in a window of the image processing application. Here, the read image data is data of the correct-exposure image, in association with which the additional information and the additional image are recorded.

Upon receiving, for the displayed image, an instruction to execute dynamic-range expansion processing from the user as a result of the user operating a menu of the image processing application for example, the control unit 801 instructs the image processing unit 804 to execute dynamic-range expansion processing. Thus, the image processing unit 804 executes dynamic-range expansion processing described in the following.

A decoding unit 1501 extracts, from the container-format data file stored in the RAM 103, data of the correct-exposure image, data of the additional information, and data of the additional image.

Based on the additional information and the additional image, a dynamic-range expansion processing unit 1502 applies processing for expanding the dynamic range to one of the correct-exposure image and the underexposure image. The dynamic-range expansion processing unit 1502 stores the processed image data in the RAM 803. The operations of the dynamic-range expansion processing unit 1502 will be described in detail later.

A posterior adjustment unit 1503 applies predetermined posterior adjustment to the data of the image to which the dynamic-range expansion processing has been applied. For example, the posterior adjustment involves the adjustment of color and brightness, the adjustment of the tone curve, etc., as designated by the user. Upon completion of the posterior adjustment, the control unit 801 records the data of the visible-light image to which the posterior adjustment has been applied to the recording unit 805 as image data to which the dynamic-range expansion processing has been applied.

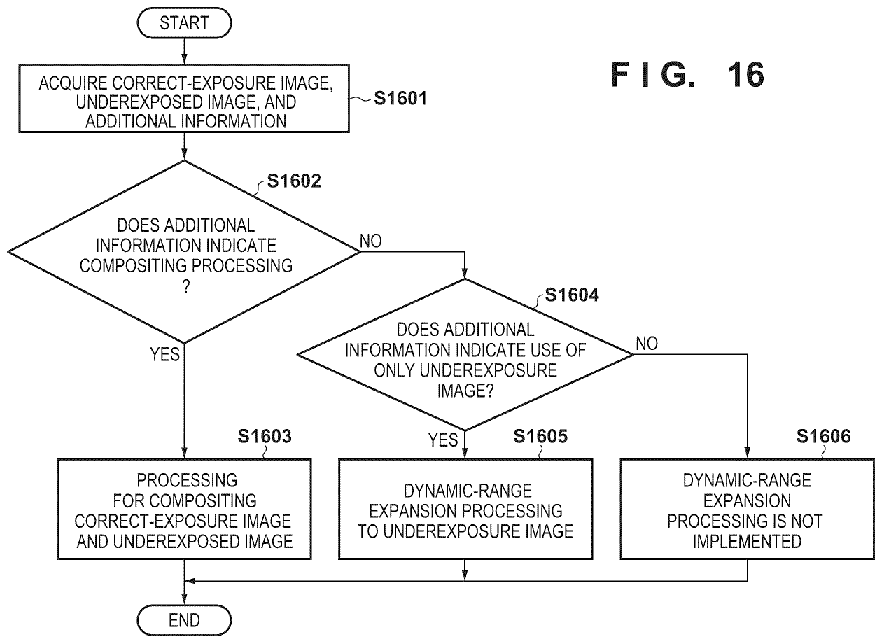

The operations of the dynamic-range expansion processing unit 1502 will be described in detail with reference to the flowchart illustrated in FIG. 16.

In step S1601, the dynamic-range expansion processing unit 1502 refers to the data of the additional information extracted by the decoding unit 1501.

In step S1602, the dynamic-range expansion processing unit 1502 determines whether or not the additional information indicates compositing processing, and executes step S1603 if it is determined that the additional information indicates compositing processing and otherwise executes step S1604.

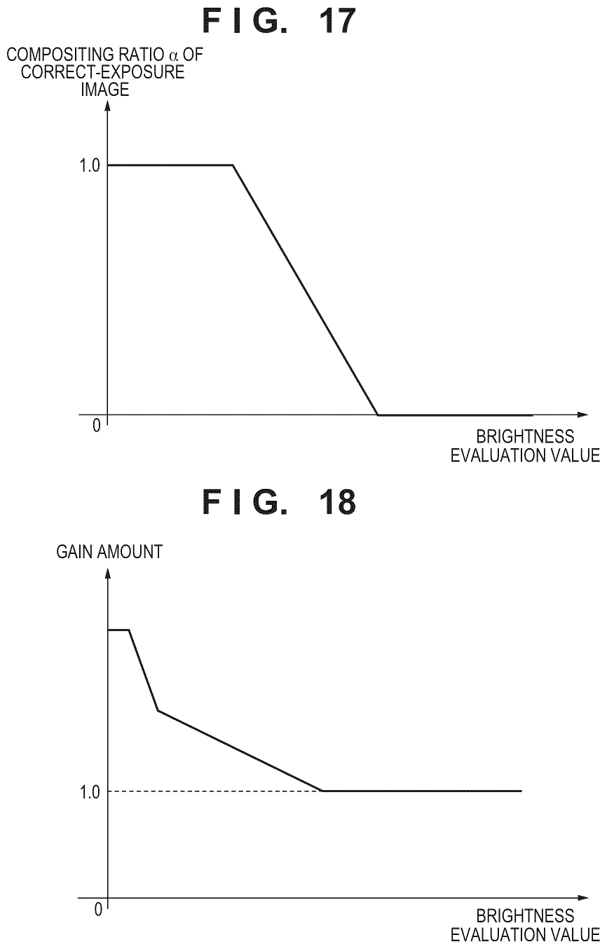

In step S1603, the dynamic-range expansion processing unit 1502 generates an image with an expanded dynamic range by compositing the correct-exposure image and the underexposure image, which is the additional image. FIG. 17 is a diagram illustrating an example of the relationship between a brightness evaluation value of the correct-exposure image and a compositing ratio α of the correct-exposure image in the processing for compositing the correct-exposure image and the underexposure image.

The correct-exposure image and the underexposure image are composited in units of individual pixels. Accordingly, the brightness evaluation value of the correct-exposure image may be the luminance value of a target pixel to which the compositing processing is being applied, for example. Upon expanding the dynamic range by compositing the underexposure image, the compositing ratio of the underexposure image is increased at bright portions of the correct-exposure image (in particular, portions that are close to the saturation level). Accordingly, the compositing ratio α illustrated in FIG. 17 has characteristics such that: the underexposure image is not composited at low-luminance portions; the correct-exposure image is replaced with the underexposure image at high-luminance portions; and, at intermediate-luminance portions, the compositing ratio α decreases as luminance increases.

In accordance with the characteristics illustrated in FIG. 17, the dynamic-range expansion processing unit 1502 determines the compositing ratio α of the correct-exposure image to be applied to the target pixel in the correct-exposure image. Furthermore, the dynamic-range expansion processing unit 1502 applies compositing processing to the target pixel in accordance with Formula (1) below.

X=α×A+(1−α)×B (1)

Here, X is the luminance value after the compositing, A is the luminance value of the target pixel, and B is the luminance value of the corresponding pixel in the composited image. The dynamic-range expansion processing unit 1502 generates a composite image in which the dynamic range of the correct-exposure image has been expanded by similarly applying the compositing processing to each pixel in the correct-exposure image.

The dynamic-range expansion processing unit 1502 updates the image in the application window to the composite image with an expanded dynamic range, and terminates the dynamic-range expansion processing.

In step S1604, the dynamic-range expansion processing unit 1502 determines whether or not the additional information indicates the use of only the underexposure image, and executes step S1605 if the additional information indicates the use of only the underexposure image and otherwise executes step S1606.

In step S1605, the dynamic-range expansion processing unit 1502 expands the dynamic range of the underexposure image by applying gradation-conversion processing to the underexposure image, which is the additional image. FIG. 18 is a diagram illustrating an example of the characteristics of the gradation conversion applied to the underexposure image for dynamic-range expansion. The characteristics of the gradation conversion are defined by the relationship between a brightness evaluation value of a pixel and the gain level to be applied.

The gradation-conversion processing of the underexposure image is performed in units of individual pixels. Accordingly, the brightness evaluation value of the underexposure image may be the luminance value of a target pixel to which the gradation-conversion processing is being applied, for example. Upon expanding the dynamic range by applying the gradation-conversion processing to the underexposure image, the gradation of dark portions of the underexposure image is enhanced. Thus, the gain amount illustrated in FIG. 18 is such that, at high-luminance portions, brightness is not changed as a result of the gain amount being set to 1. On the other hand, the gain amount illustrated in FIG. 18 has a characteristic such that, at low-luminance portions, a gain amount exceeding 1 is set and the gain amount increases as luminance decreases. However, the increase of the gain amount relative to the decrease in luminance is not constant, and the increase ratio is greater at a section where luminance is lower. Furthermore, the increase of the gain amount is very small at a section where the luminance value is close to 0.

In accordance with the characteristics illustrated in FIG. 18, the dynamic-range expansion processing unit 1502 determines the gain amount to be applied to the target pixel in the underexposure image. Furthermore, the dynamic-range expansion processing unit 1502 applies the gradation-conversion processing to the underexposure image by multiplying the luminance value of the target pixel by the determined gain amount.

The dynamic-range expansion processing unit 1502 updates the image in the application window to the underexposure image with an expanded dynamic range, and terminates the dynamic-range expansion processing.

In step S1606, the dynamic-range expansion processing unit 1502 terminates the dynamic-range expansion processing without executing any processing. In doing so, the dynamic-range expansion processing unit 1502 may display, on the display unit 806, a message dialogue indicating that the dynamic-range expansion processing cannot be applied to the displayed correct-exposure image.

Upon shooting multiple frames of visible-light images with difference exposure amounts, the image capture apparatus in the present embodiment generates additional information indicating the type of visible-light image that is suitable for dynamic-range expansion processing or a suitable dynamic-range expansion method. Furthermore, the image capture apparatus records the additional information in association with the multiple frames of visible-light images. Thus, an external apparatus can easily execute the expansion of the dynamic range of a visible-light image according to a suitable method by referring to the additional information.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-124991, filed on Aug. 4, 2022, which is hereby incorporated by reference herein in its entirety.

What is claimed is:

1. An image capture apparatus that can acquire a visible-light image and an invisible-light image, the image capture apparatus comprising:
one or more processors that execute a program stored in a memory and thereby function as:
a determination unit configured to determine a method of using information in order to apply predetermined processing to the visible-light image, wherein the information is based on the invisible-light image;
a generation unit configured to generate information based on the invisible-light image in accordance with the result of the determination; and
a recording unit configured to record, in a recording medium, a data file with which the visible-light image, information indicating the result of the determination, and the information based on the invisible-light image generated by the generation unit are associated.

2. The image capture apparatus according to claim 1, wherein the determination unit determines the method based on shooting settings of the invisible-light image or the movement of the image capture apparatus when the invisible-light image was shot.

3. The image capture apparatus according to claim 2, wherein the determination unit determines that information based on the invisible-light image is unsuitable for use in a case where a shutter speed when the invisible-light image was shot is slower than a first speed threshold or in a case where the movement of the image capture apparatus when the invisible-light image was shot is greater than a first movement threshold.

4. The image capture apparatus according to claim 3, wherein the generation unit does not generate the information based on the invisible-light image in a case where the determination unit determines that information based on the invisible-light image is unsuitable for use.

5. The image capture apparatus according to claim 3, wherein the determination unit determines a first method in a case where the shutter speed when the invisible-light image was shot is not slower than the first speed threshold and slower than a second speed threshold, or in a case where the movement of the image capture apparatus when the invisible-light image was shot is smaller than the first movement threshold and greater than a second movement threshold.

6. The image capture apparatus according to claim 5,
wherein the predetermined processing is processing for improving the visibility of the visible-light image, and
in a case where the determination unit determines the first method, the generation unit generates, based on the invisible-light image and the visible-light image, a gain map to be applied to the visible-light image.

7. The image capture apparatus according to claim 2, wherein the determination unit determines the method additionally based on the brightness of the visible-light image.

8. The image capture apparatus according to claim 7, wherein the determination unit determines a second method in a case where the brightness of the visible-light image is lower than a brightness threshold, and determines a third method in a case where the brightness of the visible-light image is higher than or equal to the brightness threshold.

9. The image capture apparatus according to claim 8,
wherein the predetermined processing is processing for improving the visibility of the visible-light image, and
in a case where the determination unit determines the second method, the generation unit generates an AC image of the invisible-light image.

10. The image capture apparatus according to claim 8,
wherein the predetermined processing is processing for improving the visibility of the visible-light image, and
in a case where the determination unit determines the third method, the generation unit uses the invisible-light image as the information based on the invisible-light image.

11. The image capture apparatus according to claim 1, wherein the generation unit adjusts the quality of the invisible-light image in accordance with the result of the determination, and uses the invisible-light image with adjusted quality as the information based on the invisible-light image.

12. The image capture apparatus according to claim 1, wherein the invisible-light image is an infrared-light image.

13. An image processing apparatus comprising one or more processors that execute a program stored in a memory and thereby function as:
an acquisition unit configured to acquire the data file recorded by the image capture apparatus according to claim 1;
an extraction unit configured to extract, from the data file, the information indicating the result of the determination, the visible-light image, and the information based on the invisible-light image; and
a processing unit configured to apply the predetermined processing to the visible-light image by using the information based on the invisible-light image according to the method indicated by the information indicating the result of the determination.

14. An image capture apparatus control method to be executed by an image capture apparatus that can acquire a visible-light image and an invisible-light image, the image capture apparatus control method comprising:
determining a method of using information in order to apply predetermined processing to the visible-light image, wherein the information is based on the invisible-light image;
generating information based on the invisible-light image in accordance with the result of the determination in the determining; and
recording, in a recording medium, a data file with which the visible-light image, information indicating the result of the determination, and the information based on the invisible-light image generated by the generating are associated.

15. An image capture apparatus that can record a first visible-light image shot with correct exposure and a second visible-light image shot with an exposure amount lower than the correct exposure, the image capture apparatus comprising one or more processors that execute a program stored in a memory and thereby function as:
a determination unit configured to determine a method of expanding a dynamic range of the first visible-light image or the second visible-light image; and
a recording unit configured to record, in a recording medium, a data file with which information indicating the result of the determination, and at least the second visible-light image out of the first visible-light image and the second visible-light image are associated.

16. The image capture apparatus according to claim 15, wherein the determination unit determines one of a plurality of methods including a first method in which the first visible-light image and the second visible-light image are composited, and a second method in which gradation conversion is applied to the second visible-light image.

17. An image capture apparatus control method to be executed by an image capture apparatus that can record a first visible-light image shot with correct exposure and a second visible-light image shot with an exposure amount lower than the correct exposure, the image capture apparatus control method comprising:
determining a method for expanding a dynamic range of the first visible-light image or the second visible-light image; and
recording, in a recording medium, a data file with which information indicating the result of the determination, and at least the second visible-light image out of the first visible-light image and the second visible-light image are associated.

18. A non-transitory computer-readable medium having stored therein a program for causing a computer included in an image capture that can acquire a visible-light image and an invisible-light image, to function as:
a determination unit configured to determine a method of using information in order to apply predetermined processing to the visible-light image, wherein the information is based on the invisible-light image;
a generation unit configured to generate information based on the invisible-light image in accordance with the result of the determination; and
a recording unit configured to record, in a recording medium, a data file with which the visible-light image, information indicating the result of the determination, and the information based on the invisible-light image generated by the generation unit are associated.

19. A non-transitory computer-readable medium having stored therein a program for causing a computer to function as an image processing apparatus comprising:
an acquisition unit configured to acquire the data file recorded by the image capture apparatus according to claim 1;
an extraction unit configured to extract, from the data file, the information indicating the result of the determination, the visible-light image, and the information based on the invisible-light image; and
a processing unit configured to apply the predetermined processing to the visible-light image by using the information based on the invisible-light image according to the method indicated by the information indicating the result of the determination.

20. A non-transitory computer-readable medium having stored therein a program for causing a computer, included in an image capture apparatus that can record a first visible-light image shot with correct exposure and a second visible-light image shot with an exposure amount lower than the correct exposure, to function as:
a determination unit configured to determine a method of expanding a dynamic range of the first visible-light image or the second visible-light image; and
a recording unit configured to record, in a recording medium, a data file with which information indicating the result of the determination, and at least the second visible-light image out of the first visible-light image and the second visible-light image are associated.
